(19) United States
(12) Patent Application Publication
(10) Pub. No.: US 2001/0032197 A1
(43) Pub. Date: Oct. 18, 2001

(54) System and process for transactional infrastructure for energy distribution

(76) Inventors: Gautam Chandra, Boston, MA (US); Jon Sorenson, Boxford, MA (US); Anthony Lopez-Lopez, Belle-Meade, NJ (US); Douglas Moore, Winchester, MA (US); Mark Benigno, Red Bank, NJ (US); Jonathan Fleisig, New York, NY (US); Todd J. Gross, North Caldwell, NJ (US); William Perlman, Fairfield, CT (US); Elisha Rothman, New York, NY (US)

Correspondence Address: PERKINS, SMITH & COHEN LLP, ONE BEACON STREET, 30TH FLOOR, BOSTON, MA, 02108, US

(21) Appl. No.: 09/748,533

(22) Filed: Dec. 22, 2000

Related U.S. Application Data
(60) Provisional application No. 60/184,897, filed on Feb. 25, 2000.

(51) Int. Cl. G06F 17/60

(52) U.S. Cl. 705/412

(57) ABSTRACT

A system and process for providing a transaction infrastructure for matching user demand for a commodity such as energy across multiple sources and levels of distribution. A transaction hub is provided that normalizes transaction information across a plurality of distribution points. Scheduling and billing of users is managed at the hub, allowing fine and dynamic load balancing across multiple sources and levels.

### CROSS REFERENCE TO RELATED APPLICATIONS

This application claims priority of U.S. Provisional Application Ser. No. 60/184,897 filed Feb. 25, 2000 entitled SYSTEM AND PROCESS FOR TRANSACTIONAL INFRASTRUCTURE FOR ENERGY DISTRIBUTION.

### FIELD OF THE INVENTION

This invention relates to a system and process for managing diverse transactions in multi-level distribution of fungible commodities, such as energy.

### BACKGROUND

The deregulation of the electric power industry, mandating the opening of different segments of the physical delivery system, has led to new opportunities and to dislocation of traditional players, resulting in some inefficiencies. One example is that owners of smaller hydroelectric plants find it difficult to find users for their power. Low margins in the energy distribution industry relative to the telecommunications industry and users' inertia in face of limited efforts of new players to enter the local distribution market have left the industry operating below optimum levels.

On the other hand, the wide and open availability of communications networks such as the Internet provides possibilities for the re-linking of the one or more of the existing energy distribution networks dynamically as driven by market and physical environmental forces, resulting in more optimal distribution.

Hitherto, the Internet has been used to market to consumers the local distribution services of new entrants in that segment. While this achieves some local efficiency in the market mechanism, it does not meet the issues of upstream distribution.

### SUMMARY OF THE INVENTION

It is an object, therefore, of the present invention to better match the downstream demand for energy with the widest range of upstream supply available at all convenient entry points.

In the embodiment set forth herein, energy may be purchased from a wholesale marketer, a wholesale distributor or a local distributor and sold to business and residential users through a marketing channel or partner. A key aspect of the invention is a hub architecture that provides a transaction infrastructure using normalized transaction objects to allow seamless purchases at each entry point and delivery to and billing of the user as if the entire distribution system were operated as a single organic entity.

The transaction hub consists of the core engines and data transformation services. The core engines perform essential business functions including enrollment, procurement and billing. The data transformation services act as translation engines that map incoming data from various external formats into a relational database in the core of the transaction hub and vice-versa for outgoing data.

The invention has the benefits of allowing mixing and matching of different energy sources where physically possible. Because of the aggregation of energy sources at different levels of the distribution chain, the system allows for finer load balancing across different parties and levels of distribution. This has the additional benefit of facilitating more precise matching of supply to expected demand based on averaging and a variety of pricing plans for the user based on average or expected use.

### BRIEF DESCRIPTION OF THE DRAWINGS

FIG. 1 is a schematic view of the transactional infrastructure system.

FIG. 2 is a schematic view of the transaction hub architecture.

FIG. 3 is a schematic view of the incoming data transformation services.

FIG. 4 is a schematic view of the outgoing data transformation services.

FIGS. 5A & 5B are schematic views of the transactional infrastructure system showing the applicable functional engines of the transaction hub.

FIG. 6A is the first portion of a flow diagram of the process of the invention including initial enrollment of users.

FIG. 6B is the second portion of a flow diagram of the process of the invention including billing of users.

### DESCRIPTION OF PREFERRED EMBODIMENTS

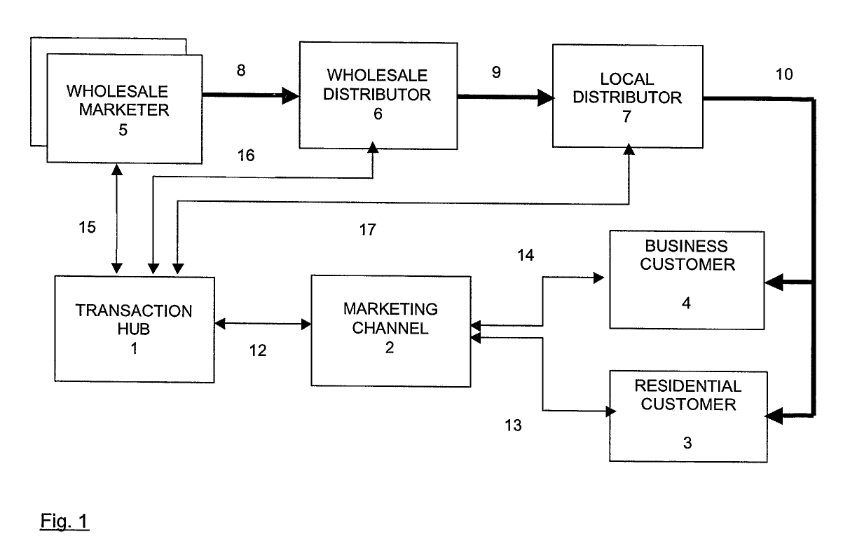

FIG. 1 shows the transaction infrastructure with transaction hub 1 at its core.

Marketing channel or partner 2 is any entity marketing goods or services to end customers. A marketing channel 2 may supply only the goods or services of the owner of the transaction hub 1; it may supply its own goods and services; it may supply only goods and services from other parties; or it may supply some combination of these. The transaction hub 1 may itself be a marketing channel 2 in certain instances. Examples of marketing channels 2 include, but are not limited to, direct marketers, internet marketers, telemarketers, energy companies and utilities, communications companies including phone, data, voice, wireless, fiber optic, and internet, retailers, real estate companies, or franchisees of the transaction hub 1.

Residential customers 3 are consumers who buy goods or services for individual or multiple households or as part of aggregation groups. Examples of aggregation groups include buying clubs, religious or civic affinity groups, or marketing organizations.

Business customers 4 are customers who buy goods or services for small or large businesses. Businesses may have single or multiple facilities. Customers may buy for full or partial requirements of goods and services. Customers may buy directly or through buying agents.

Wholesale marketers 5 are entities providing products and services or inputs for products and services sold by the owner of transaction hub 1. Products and services may be physical goods and services or financial products used to hedge price or volumetric exposure to transaction hub 1/s business. Examples of wholesale marketers 5 include, but are not limited to power generation companies, power marketers, independent power producers, electric and gas utilities, natural gas producers, natural gas marketer, natural gas storage owners and operators, exchange traded or OTC commodities markets, fuel oil marketers and distributors, cable operators, and all other players providing communication bandwidth and content.

Wholesale distributor 6 is an entity providing distribution services for bulk products and services purchased by them and also entities that move products and services purchased by the transaction hub 1 across state boundaries. Examples of wholesale distributors 6 include, but are not limited to interstate natural gas and other fuel pipelines, railroads, ground transportation companies, power exchanges, electric transmission companies, electric independent system operators, communication infrastructure.

Local distributor 7 is an entity providing delivery service of products and services at the local level. Local distributors 7 may also be competitors of the operator of transaction hub 1 in the supply of products themselves. Local distributors 7 may offer services to end customers 3 or 4 independently of the owner of transaction hub 1. Examples of local distribution companies (LDCs) include electric, natural gas, water, phone, and cable utilities, fuel oil distributors, Internet service providers, wireless data and voice carriers, and other local delivery companies.

In both the existing system and in the invention, flow of energy (electrical power, natural gas, oil) occurs along the path 8 from the wholesale marketer (producer) 5 to the wholesale distributor 6, the path 9 from the wholesale distributor 6 to the local distributor 7, and the path 10 from the local distributor 7 to the customers 3 and 4. What is changed on this path is the scheduling and mix of flows from different sources at the distribution levels represented by the wholesale marketer 5, the wholesale distributor 6 and the local distributor 7.

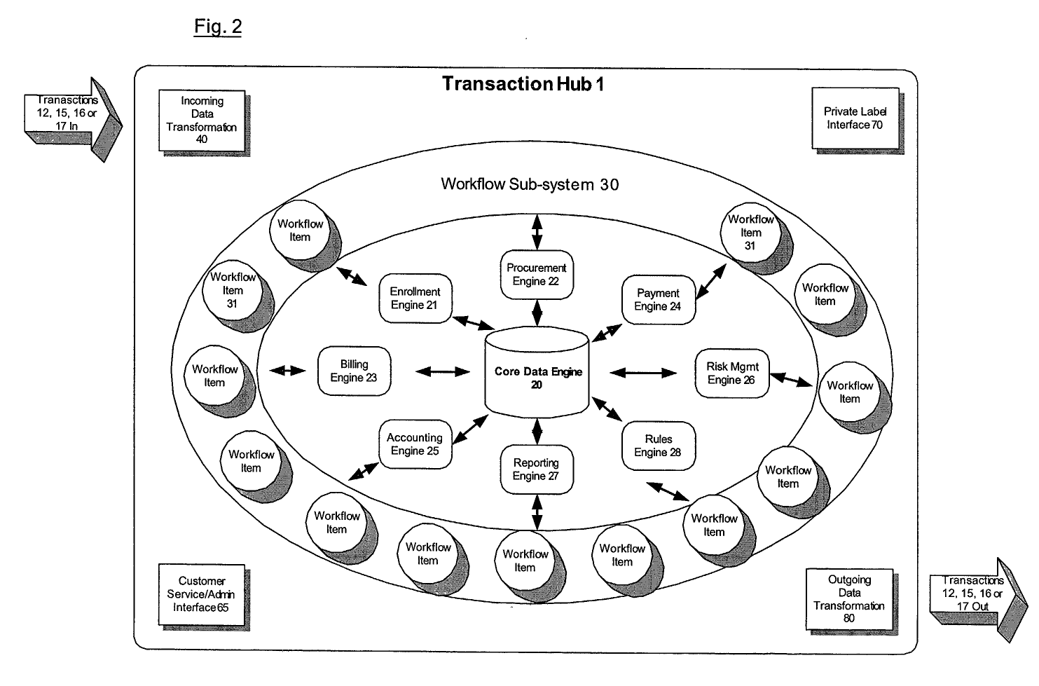

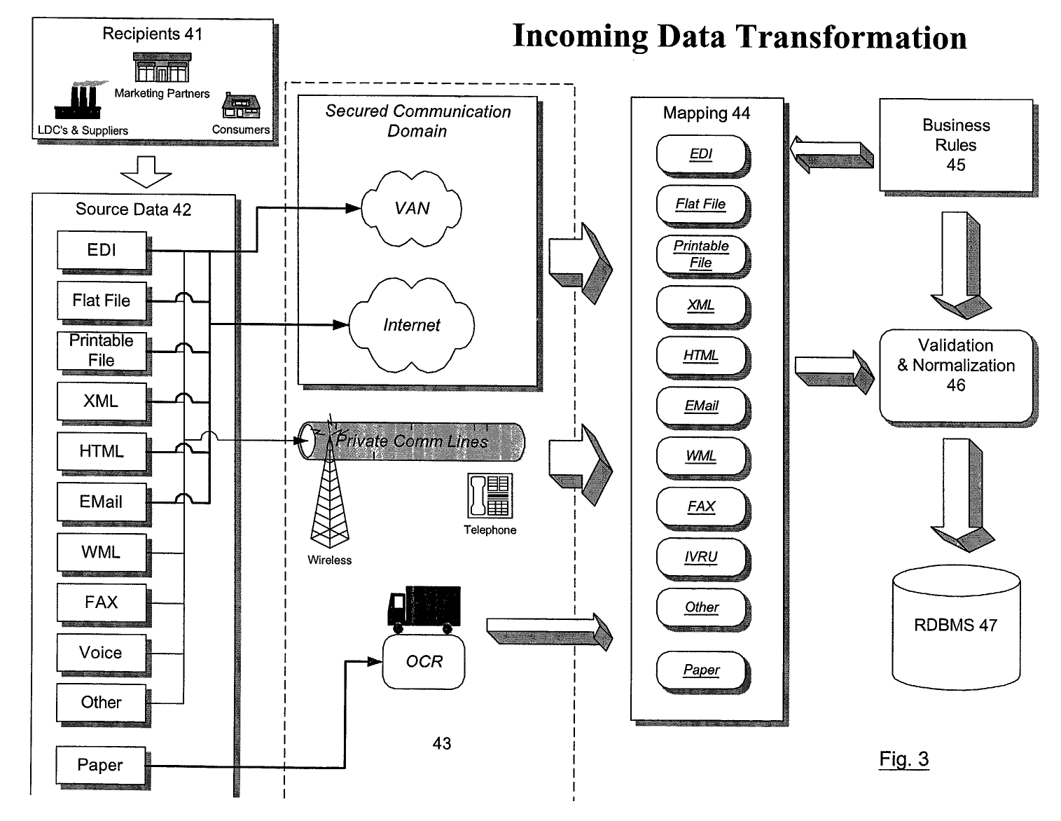

FIG. 2 shows the transaction hub 1 architecture with the core data engine 20, the core functional engines 21-28, the workflow sub-system 30, workflow items 31, and several other services/modules. The core functional engines include the enrollment engine 21, procurement engine 22, billing engine 23, payment processing engine 24, accounting engine 25, risk management engine 26, reporting & analysis engine 27 and rules engine 28.

The enrollment engine 21 is a system module that handles utility enrollment for customers with LDCs. The customers can enroll either directly with the owner of the transaction hub 1 or through one of its partners. The enrollment engine 21 interacts with the LDCs' IT systems to exchange information about the customer.

The procurement engine 22 is a system module that is used to facilitate the scheduling of energy commodity from suppliers. The billing engine 23 is a system module that generates customer invoices. The billing engine 23 takes inputs (i.e. meter reads, charges, taxes, etc.) from LDCs and calculates commodity charges, transportation charges, taxes, and credits based on pricing rules.

The payment processing engine 24 is a system module that handles online payment collection and transaction through a third-party payment service provider and a merchant bank over the Internet. The accounting engine 25 is a system module that handles payables, receivables, and taxes for corporate partners and customers.

The risk management engine 26 is a system module that is used to do risk management for energy procurement and product design (i.e. come up with pricing schemes such as flat rate). The reporting & analysis engine 27 is a system module that outputs statistics on customers, partners, and the transaction hub 1 itself. The information it reports will be used for, but not limited to, marketing and analysis purposes.

The functions of these various engines will be governed by business rules that reside in the dynamic rules engine 28. The rules engine 28 is a system module that stores all business and system rules to be used by other modules to process information flowing through the transaction hub 1. Rules can be dynamically changed by the administration via a separate administration console 65 and automatically reflected in other modules. The rules engine 28 offers a flexible and scalable mechanism to other engines for performing their respective business functions without having to hard-code business rules into the system. It also enables the administrators of the transaction hub 1 to change the rules at run-time without impacting the live system.

The workflow sub-system 30 interfaces with all other modules/engines to move transaction items from one state to another. Transactional items in the transaction hub 1 are specified as workflow items 31 in the workflow subsystem 30. The workflow subsystem 30 performs the low level transportation of any items following specific rules from the rules engine 28. Every workflow item 31 coming into or going out of the transaction hub 1 will travel through different stages in the workflow subsystem 30. For example, a customer enrollment request coming in from a marketing partner 2 will flow through the workflow subsystem 30 where the parameters and entrance rules of the stages are specified by the rules engine 28. Thus in essence, the workflow subsystem 30 acts as a router that directs and optimizes transactional “traffic” flowing through the transaction hub 1.

The transaction hub 1 also includes a customer service/administration interface module 65, a private label interface module 70, and incoming and outgoing data transformation services.

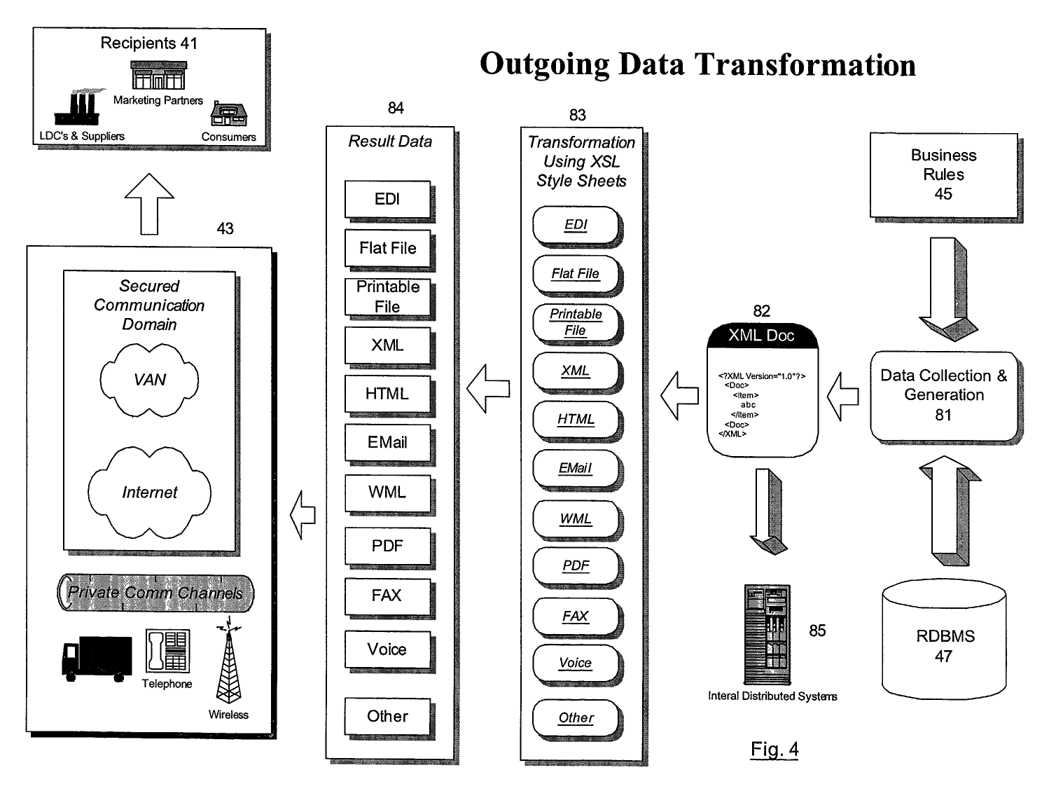

FIG. 3 shows the incoming data transformation services 40 and FIG. 4 shows the outgoing data transformation services 80. Both data transformation services act as translation engines that interface between the core functional engines and foreign data sources 41. Foreign data sources 41 include marketing partners 2, local distributors 7 and suppliers, or consumers.

During the incoming data transformation 40, the incoming data 42 may be received in a variety of formats. Some of the popular incoming data formats 42 include EDI, XML, Flat ASCII Files, Print Files, HTML, and Fax/OCR. The transmission of the incoming data 42 can be carried by any popular media 43 including the Internet, EDI VANS, private/leased lines, and wireless (PDA).

The mapping function 44 allows data to be manipulated in virtually any format as long as it is well defined. The business rules 45 supplied by the rules engine 28 determine how the data is to be manipulated. The normalized, mapped data 46 is placed into a relational database 47 where it enters the transaction hub 1. After the transaction hub 1 performs the appropriate function(s), the information is sent to the outgoing data transformation service 80. The relational database 47, with input from the business rules 45, generates and collects data 81. The outbound data mapping interface utilizes XML as a normalized data format 82 to store transaction elements and attributes. The XML document 82 may be transformed using XSL style sheets 83 into the desired resulting format 84 or the XML document may be sent to internal distributed systems 85. The outgoing data 84 is transmitted by any popular media 43 back to the foreign data sources 41.

The goal of the transaction hub 1 is to facilitate energy procurement, billing, and service transactions among multiple business entities that potentially operate drastically different IT systems. The data normalization accomplished by the data transformation services is a key to the transaction hub 1 architecture.

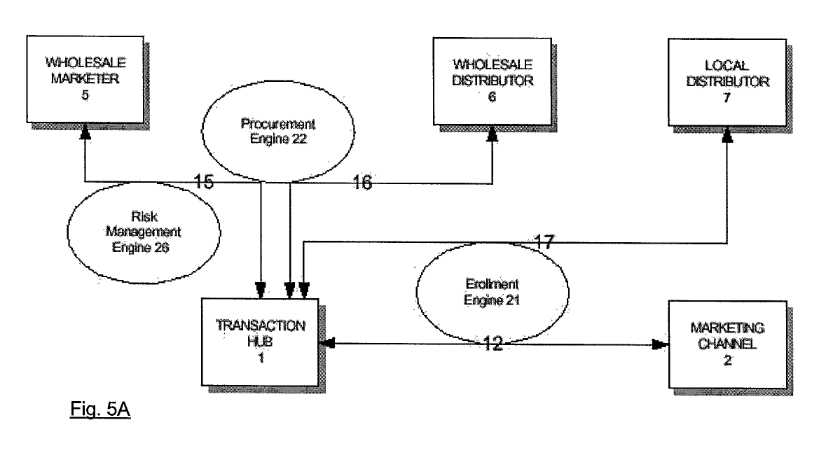

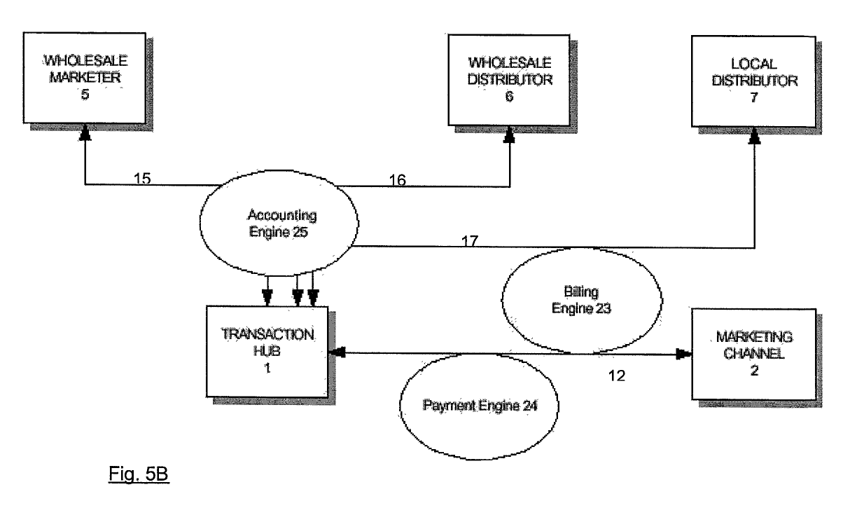

FIGS. 5A and 5B show the transaction infrastructure with the applicable functional engines of the transaction hub 1.

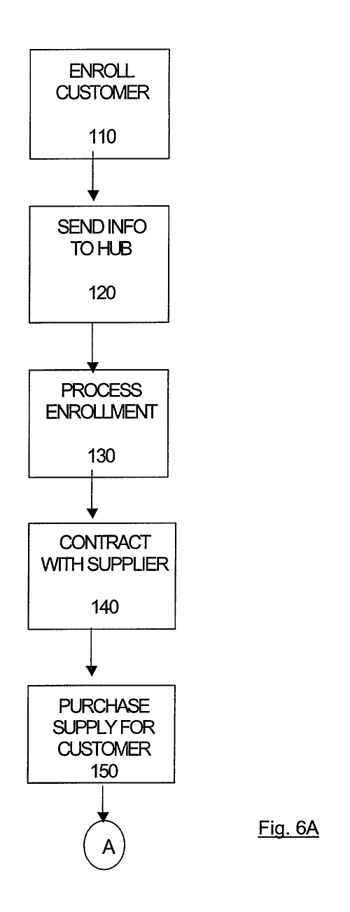

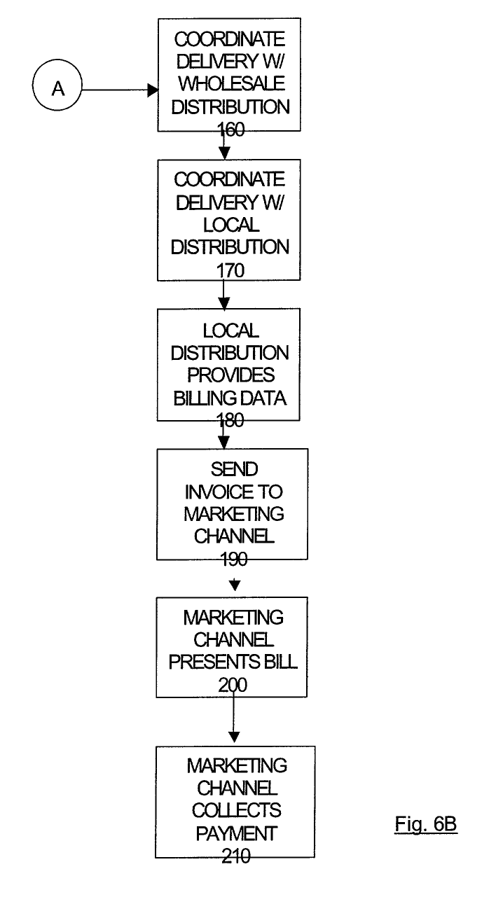

FIGS. 6A and 6B show the process flow of the invention for the invention applied to electric power and natural gas delivery, but may be applied to other multi-level distribution of fungible commodities.

The process begins with enrollment 110 of a customer in an interaction represented by transactions 13 and 14. Marketing channel 2 presents a product choice, and customer 3 or 4 chooses. The customer chooses the product (including specifications) and provides contact, service, delivery and billing information.

In step 120, marketing channel 2 passes all the customer information using either a batch or real-time interface depicted as transaction 12.

The transaction hub 1 processes the customer enrollment in step 130 using the enrollment engine 21. Transaction hub 1 informs the local distribution company 7 that customer 3 or 4 has switched supplier and receives customer information including amounts of past deliveries, past bills, and payment history. If the local distributor 7 was not the previous supplier, the transaction hub 1 might receive only partial information. This information is normalized in that transaction information from different levels of distribution share the same form. The transaction hub 1 analyzes the customer's requirements and aggregates requirements by supplier. This may be modified in close to real time.

Transaction hub 1 then contracts in step 140 with suppliers such as wholesale marketers 5 in transaction 15. The contract terms include delivery locations, quantities, prices, payment information, and other terms and conditions. These may be long-term contracts or short, standard forms. Again, the terms may be standardized to facilitate dynamic load balancing.

In step 150, transaction hub 1 purchases supply for customer requirements in transaction 15. Suppliers 5 pass back purchase confirmations and delivery schedules. After completion of delivery, the supplier 5 sends delivery receipts and invoices to the transaction hub 1. Transaction hub 1 then remits payment to the supplier 5. This is done using the normalized transaction “language”.

Transaction hub 1 coordinates delivery with wholesale distributor 6 by sending a delivery schedule to the distributor and receiving a schedule confirmation in transaction 16, step 160. Wholesale distributor 6 subsequently sends back an actual delivery schedule. The wholesale distributor 6 sends back delivery receipts and invoices. Transaction hub 1 remits payment for delivery to the wholesale distributor. This process may be done by the transaction hub 1 or by the supplier 5 on behalf of the transaction hub 1. The procurement engine 22 is utilized to facilitate the scheduling with both the suppliers 5 and the distributors 6 in transactions 15 and 16.

Transaction hub 1 then coordinates delivery with the local distributor 7 in step 170, in transaction 17. This includes sending the delivery schedule to the local distributor 7 who sends back a confirmation and an actual delivery schedule. This process may be performed by the transaction hub 1 or by the supplier 5 on behalf of the transaction hub 1. The accounting engine 25 interacts with the suppliers 5, the wholesale distributor 6, and the local distributor 7 in order to handle payables, receivables, and taxes for corporate partners and customers.

In step 180, local distributor 7 supplies transaction hub 1 with billing inputs, including the actual delivery amounts to customer 3 or 4, which may be calculated, read from a metering device, or estimated. The local distributor 7 also passes the charges incurred for use of the local distribution services to the transaction hub 1, which remits payment. The payment, part of transaction 17, may be made before or after collection of funds from the marketing channel 2 or from customers 3 or 4.

In step 190, transaction hub 1 calculates invoices to be paid by the customer for product purchases (including charges for supply of product, delivery of product, and applicable taxes) using the billing engine 23. The billing engine 23 has been developed to assemble diverse information from multiple sources. Transaction hub 1 then passes the detailed customer invoices to the marketing channel 2 as well as its own invoices for services. In transaction 12, the marketing channel 2 remits payment either before or after collection from customer 3 or 4.

The marketing channel 2 bundles the invoice from transaction hub 1 with other invoices to the customer and calculates a total bill in step 200. In transaction 13 or 14, marketing channel 2 presents the total bill to customer 3 or 4 respectively. The bill may be paper or electronic, and the delivery mechanism may be mail, fax, delivery service, e-mail, Internet, or telephone. The bill presentment may also be made by transaction hub 1 or by a third party.

In step 210, the marketing channel 2 collects the billed amounts from customer 3 or 4. In transactions 13 or 14, customer 3 or 4 respectively remits payment to marketing channel 2 for the billed amounts. Payments may be made by cash, check, money order, credit card, debit card, or electronic fund transfer through mail, fax, delivery service, phone, e-mail or Internet. Payment processing may be initiated by the customer or may occur automatically. Payment processing may also be done by transaction hub 1 using the payment processing engine 24 or by a third party.

The flexibility of this system of the invention allows very fine adjustment of supply to meet demand. The risk management engine 26 assesses the risk for energy procurement and product design and allows for efficient and economical new products based on predicted consumption by a user. The first is a “one rate” product in which a customer's 12-month historical high consumption is set as a maximum monthly usage for a set, generally, discounted fee. A second is an “insurance” product that uses the same history to establish a fixed fee even if the user goes above the previous high consumption. A third product is “prepaid,” in which a year's consumption is paid up front based on a two-year usage history.

The invention herein may be used in other property and casualty risk-management systems. It is to be understood that the above-described embodiments are simply illustrative of the principles of the invention. Various and other modifications and changes may be made by those skilled in the art that will embody the principles of the invention and fall within the spirit and scope thereof.

What is claimed is:

1. A system for providing a commodity to multiple users, said system comprising:
(a) a transaction hub including:
(i) storage for information on supply of said commodity at multiple distribution nodes;
(ii) storage for information on demand for said commodity by multiple users;
(iii) logic matching said supply and demand information; and
(b) at least two distribution nodes at different levels of distribution each communicating with said transaction hub and responsive to said matching.

2. The system of claim 1 wherein said matching includes matching of supply with the aggregate demand of multiple users.

3. The system of claim 1 wherein said distribution nodes include a wholesale distributor and a local distributor.

4. The system of claim 1 wherein said distribution nodes include a wholesale marketer and a wholesale distributor.

5. The system of claim 1 wherein said distribution nodes include a wholesale marketer and a local distributor.

6. The system of claim 3 further comprising a wholesale marketer node communicating with said transaction hub and responsive to said matching of supply and demand.

7. The system of claim 1 wherein said commodity is electricity and said users include business customers and residential customers.

8. The system of claim 7 further comprising a marketing channel for communicating with at least one of said classes of business or residential customers.

9. The system of claim 1 wherein said commodity is natural gas and said users include business customers and residential customers.

10. The system of claim 9 further comprising a marketing channel for communicating with at least one of said classes of business or residential customers.

11. The system of claim 1 wherein said commodity is a petroleum fuel and said users include business customers and residential customers.

12. The system of claim 11 further comprising a marketing channel for communicating with at least one of said classes of business or residential customers.

13. The system of claim 1 wherein said transaction hub comprises storage of information on supply of and demand for multiple commodities and logic matching availability and demand information.

14. The system of claim 13 wherein said multiple commodities are drawn from the group of energy commodities comprising electricity, natural gas and petroleum fuel.

15. The system of claim 13 wherein at least one user can substitute use of one of said multiple commodities for another of said multiple commodities.

16. A commodity transaction hub comprising:
(a) an interface providing normalization of information on availability of a commodity at multiple distribution nodes, at least two of said nodes at different levels of distribution;
(b) storage for said normalized supply information;
(c) storage for information on demand for said commodity by multiple users;
(c) logic matching said supply and demand information; and
(d) an interface communicating matches to said multiple distribution nodes.

17. The transaction hub of claim 16 wherein said matching includes matching of supply with the aggregate demand of multiple users.

18. The transaction hub of claim 16 structured in a huband-spoke architecture with a core data base and data base engine interfacing with said distribution nodes and users through multiple spokes of specialized functional engines generating work flow items.

19. The transaction hub of claim 18 having as one of said multiple spokes a business rules engine providing information mapping rules for said normalization interface and said communication interface.

20. The transaction hub of claim 18 having as one of said multiple spokes an enrollment engine for acquiring recurring demand information from said users.

21. The transaction hub of claim 18 having as one of said multiple spokes a procurement engine for acquiring recurring supply information from wholesale suppliers.

22. The transaction hub of claim 18 having as one of said multiple spokes a risk management engine for spreading supply risk over multiple wholesale suppliers.

23. The transaction hub of claim 18 having as one of said multiple spokes an accounting engine for scheduling and tracking provision of said commodity.

24. The transaction hub of claim 18 having as one of said multiple spokes a billing engine for generating user bills.

25. The transaction hub of claim 18 having as one of said multiple spokes a payment engine for receiving payments from said users.

26. In a network for distributing a commodity to a plurality of users, a distribution node adapted for communicating with a transaction hub supply information normalized across multiple levels of distribution and demand information matched by said transaction hub to said supply information of said distribution node.

27. The distribution node of claim 26 associated with a wholesale supplier and adapted to accept delivery schedules from said transaction hub.

28. A process for distributing a commodity to multiple users comprising:
(a) receiving information on supply of a commodity at multiple distribution nodes, at least two of said nodes at different levels of distribution;
(b) normalizing and storing said supply information;
(c) receiving and storing information on demand for said commodity by multiple users;
(d) matching said supply and demand information; and
(e) communicating matches to said multiple distribution nodes.

29. The process of claim 28 wherein said matching includes matching of supply with the aggregate demand of multiple users.

30. The process of claim 28 wherein the steps of normalizing and communicating include the step of information mapping.

31. The process of claim 28 wherein the step of receiving demand information from a particular one of said users is preceded by the process of enrolling, including steps of acquiring recurring demand information from said users.

32. The process of claim 28 wherein the step of receiving supply information from a wholesale supplier is preceded by the process of procuring, including steps of acquiring recurring supply information from said supplier.

33. The process of claim 28 wherein the step of communicating a match to a wholesale supplier includes the step of allocating supply risk among multiple wholesale suppliers.

34. The process of claim 28 wherein the step of communicating a match to a wholesale supplier includes the step of providing a delivery schedule followed by the step of a delivery schedule confirmation from said wholesale supplier.

35. The process of claim 28 further comprising the steps of generating an invoice and transmitting it through a marketing channel to a user.

36. The process of claim 28 further comprising the steps of collecting payment from a user through a marketing channel.
